(19) United States
(12) Patent Application Publication
(10) Pub. No.: US 2008/0198749 A1
(43) Pub. Date: Aug. 21, 2008

(54) Technique for handling service requests in an information handling system

(75) Inventors: Cuong T. Nguyen, Austin, TX (US); Joseph D. DeNiro, Austin, TX (US); Joseph Farrell, Austin, TX (US); Bruce Holmes, Austin, TX (US); Mohana Rao Mullapudi, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/676,947

(22) Filed: Feb. 20, 2007

(51) Int. Cl. H04L 12/28; H04L 12/56

(52) U.S. Cl. 370/235; 370/392

(57) ABSTRACT

A technique for handling a service request in an information handling system includes receiving, at a data link layer device, a packet transmitted from a client, the data link layer device including multiple ports. The packet is examined to determine whether the packet includes a first-type request. The packet is then routed to a server via a trusted port, included within the multiple ports, when the packet includes the first-type request.

### FIELD OF THE DISCLOSURE

This disclosure relates generally to information handling systems, and more particularly to a technique for handling service requests in information handling systems.

### BACKGROUND

As the value and use of information continues to increase, individuals and businesses seek additional ways to process and store information. One option is an information handling system. An information handling system generally processes, compiles, stores, and/or communicates information for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

In a conventional computer network, a client (e.g., a networked computer system) may obtain a unique Internet protocol (IP) address from a dynamic host configuration protocol (DHCP) server, which maintains a list of IP addresses available for assignment, responsive to a DHCP request. In at least one conventional computer network, a client has been connected to a DHCP server via an Ethernet switch having multiple ports. In this case, a DHCP request from a client connected to a port of an Ethernet switch has been included within a broadcast packet received by the Ethernet switch. The Ethernet switch has then broadcast the packet to all of the other ports of the Ethernet switch. Unfortunately, broadcasting the packet to all of the other ports of the Ethernet switch may facilitate a surreptitious response to the DHCP request by another client (e.g., a non-authorized entity such as a rogue DHCP server) connected to one of the ports of the Ethernet switch. To address this concern, at least one conventional Ethernet switch has been configured to block DHCP responses from non-trusted ports. Unfortunately, clients connected to non-trusted ports of the Ethernet switch may still receive DHCP requests from other clients and, thus, potentially receive sensitive information about other clients.

What is needed is a technique for handling a selected service request in an information handling system that decreases the probability of receiving a response to the selected service request from a non-authorized entity. It would also be desirable for the technique to provide improved security for information included within a service request.

### BRIEF DESCRIPTION OF THE DRAWINGS

It will be appreciated that for simplicity and clarity of illustration, elements illustrated in the Figures have not necessarily been drawn to scale. For example, the dimensions of some of the elements may be exaggerated relative to other elements. Embodiments incorporating teachings of the present disclosure are shown and described with respect to the drawings presented herein, in which:

FIG. 1 illustrates a block diagram of an information handling system, according to one aspect of the disclosure;

FIG. 2 illustrates a functional block diagram of a data link layer device, according to another aspect of the disclosure; and

FIG. 3 illustrates a flow diagram of a method for handling a service request for an information handling system, according to a one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings. For example, much of the following focuses on information handling systems that implement a data link layer device (e.g., an Ethernet switch) that passes broadcast packets that include certain requests to a server connected to a trusted port. The teachings may also be utilized in other applications and with several different types of architectures, such as distributed computing architectures, client/server architectures, or middleware server architectures and associated components.

As used herein, the term “coupled” includes both a direct electrical connection between elements or blocks and an indirect electrical connection provided by intervening elements or blocks. As is also used herein, the term “data link layer device” refers to a layer 2 device of the Open Systems Interconnection (OSI) reference model. As is well known, the OSI reference model is a layered, abstract description for communication and computer network protocol design. In one or more implementations, the data link layer may be split into a media access control (MAC) layer and a logical link control (LLC) layer. The disclosed techniques are broadly applicable to local area networks (LANs) and, in particular, to virtual LANs (VLANs). As is known, a VLAN includes a network of computers that operate as if the computers are directly physically connected to a same LAN segment, even though the computers may be connected to different LAN segments.

While the discussion herein is primarily directed to broadcast packets, it is contemplated that the disclosed techniques have applicability to other types of packets (e.g., multicast packets). Furthermore, while the disclosure is primarily directed to DHCP requests, it is contemplated that the disclosed techniques are broadly applicable to other types of service requests. For example, the disclosed techniques may be used to handle network game service requests. In at least some network game environments, clients have used broadcast protocol data units (PDUs) to allow clients to search for game servers, which provide access to a desired network game. Moreover, techniques disclosed herein may be used to balance a load between game servers or other types of servers.

In network game environments, a number of techniques have been employed to balance game server loads. For example, a main game server that received a broadcast game service request from a client has been configured to distribute the request to a secondary game server. As another example, a network layer device (e.g., an Ethernet router) has been configured to distribute a game service request to a game server based on various user defined policies. According to various aspects of the disclosure, a data link layer device that does not require policy based routing is employed to route packets to an appropriate server based on, for example, server load.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a personal digital assistant (PDA), a consumer electronic device, a network server or storage device, a switch, a router, a wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input/output (I/O) devices, such as a keyboard, a mouse, and a video display. The information handling system can also include one or more buses operable to transmit communications between the various hardware components.

According to one aspect of the disclosure, a method for handling a service request in an information handling system includes receiving, at a data link layer device, a packet transmitted from a client. In this case, the data link layer device includes multiple ports. The packet is examined to determine whether the packet includes a first-type request. The packet is then routed to a server via a trusted port, included within the multiple ports, when the packet includes the first-type request.

According to a further aspect of the disclosure, an information handling system includes a data link layer device and a client coupled to the data link layer device. The data link layer device includes multiple ports. The client is configured to transmit a packet to the data link layer device and the data link layer device is configured to receive and examine the packet to determine whether the packet includes a first-type request. The data link layer device is configured to route the packet to a server coupled to a trusted port, included within the multiple ports, when the packet includes the first-type request.

According to a particular embodiment of the disclosure, a data link layer device for an information handling system includes a control unit and a logic unit (e.g., an application specific integrated circuit) coupled to the control unit. In this case, the logic unit includes multiple ports. The logic unit is configured to examine a packet transmitted by a client and route the packet to the control unit, when the packet includes a first-type request. The control unit is configured to route the packet including the first-type request to a server coupled to a trusted port, included within the multiple ports, via the logic unit.

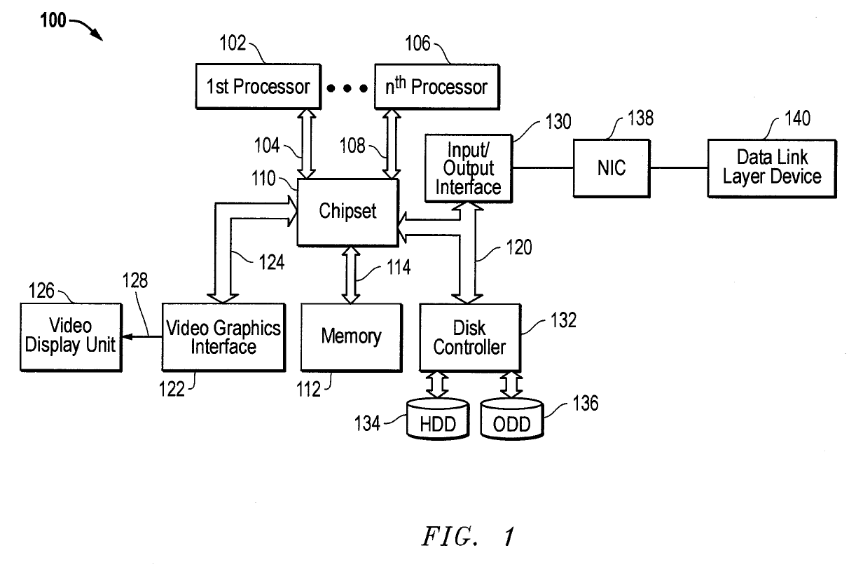

FIG. 1 illustrates a block diagram of an exemplary embodiment of an information handling system, generally designated at 100. In one form, the information handling system 100 can be a computer system such as a server or a client. As shown in FIG. 1, the information handling system 100 can include a first physical processor 102 coupled to a first host bus 104 and can further include additional processors generally designated as n^{th} physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and can allow for simultaneous processing of multiple processors and support the exchange of information within information handling system 100 during multiple processing operations.

According to one aspect, the chipset 110 can be referred to as a memory hub or a memory controller. For example, the chipset 110 can include an Accelerated Hub Architecture (AHA) that uses a dedicated bus to transfer data between the first physical processor 102 and the n^{th} physical processor 106. For example, the chipset 110 including an AHA enabled-chipset can include a memory controller hub and an I/O controller hub. As a memory controller hub, the chipset 110 can function to provide access to the first physical processor 102 using first bus 104 and the nth physical processor 106 using the second host bus 108. The chipset 110 can also provide a memory interface for accessing memory 112 using a third host bus 114. In a particular embodiment, the host buses 104, 108, and 114 can be individual buses or part of the same bus. The chipset 110 can also provide bus control and can handle transfers between the host buses 104, 108, and 114.

According to another aspect, the chipset 110 can be generally considered an application specific chipset that provides connectivity to various buses, and integrates other system functions. For example, the chipset 110 can be provided using an Intel® Hub Architecture (IHA) chipset that can also include two parts, a Graphics and AGP Memory Controller Hub (GMCH) and an I/O Controller Hub (ICH). For example, an Intel® 820E, an 815E chipset, or any combination thereof, available from the Intel Corporation of Santa Clara, Calif., can provide at least a portion of the chipset 110. The chipset 110 can also be packaged as an application specific integrated circuit ASIC.

The information handling system 100 can also include a video graphics interface 122 that can be coupled to the chipset 110 using fourth host bus 124. In one form, the video graphics interface 122 can be an Accelerated Graphics Port (AGP) interface to display content within a video display unit 126. Other graphics interfaces may also be used. The video graphics interface 122 can provide a video display output 128 to the video display unit 126. The video display unit 126 can include one or more types of video displays such as a flat panel display (FPD) or other type of display device.

The information handling system 100 can also include an I/O interface 130 that can be connected via a fifth host bus 120 to the chipset 110. The I/O interface 130 can include industry standard buses or proprietary buses and respective interfaces or controllers. The fifth host bus 120 can also include a Peripheral Component Interconnect (PCI) bus or a high speed PCI-Express bus. In one embodiment, a PCI bus can be operated at approximately 66 MHz and a PCI-Express bus can be operated at approximately 128 MHz. PCI buses and PCI-Express buses can be provided to comply with industry standards for connecting and communicating between various PCI-enabled hardware devices. Other buses can also be provided in association with, or independent of, the fifth host bus 120 including other industry standard buses or proprietary buses, such as Industry Standard Architecture (ISA), Small Computer System Interface (SCSI), Inter-Integrated Circuit (I2C), Serial Peripheral Interconnect (SPI), or Universal Serial Bus (USB) buses.

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the fifth host bus 120 operable as a PCI bus, and activities for the video graphics interface 122. The Northbridge portion can also communicate with the first physical processor 102 using first bus 104 and the n^{th} physical processor 106 using the second bus 108. The chipset 110 can also include a Southbridge portion (not illustrated) of the chipset 110 and can handle input/output (I/O) functions of the chipset 110. The Southbridge portion can manage the basic forms of I/O such as Universal Serial Bus (USB), serial I/O, audio outputs, Integrated Drive Electronics (IDE), and Industry Standard Architecture (ISA) I/O for the information handling system 100.

The information handling system 100 can further include a disk controller 132 coupled to the fifth host bus 120. The disk controller 132 can be used to connect one or more disk drives such as a hard disk drive (HDD) 134 and an optical disk drive (ODD) 136 such as a Read/Write Compact Disk (R/W-CD), a Read/Write Digital Video Disk (R/W-DVD), a Read/Write mini Digital Video Disk (R/W mini-DVD), or other type of optical disk drive. As is depicted, the information handling system 100 also includes a network interface card (NIC) 138 that is coupled to the I/O interface 130 and a port of data link layer device 140 (e.g., an Ethernet switch). Alternatively, the functions performed by the NIC 138 may be integrated within one or more integrated circuits incorporated within a subsystem of the information handling system 100.

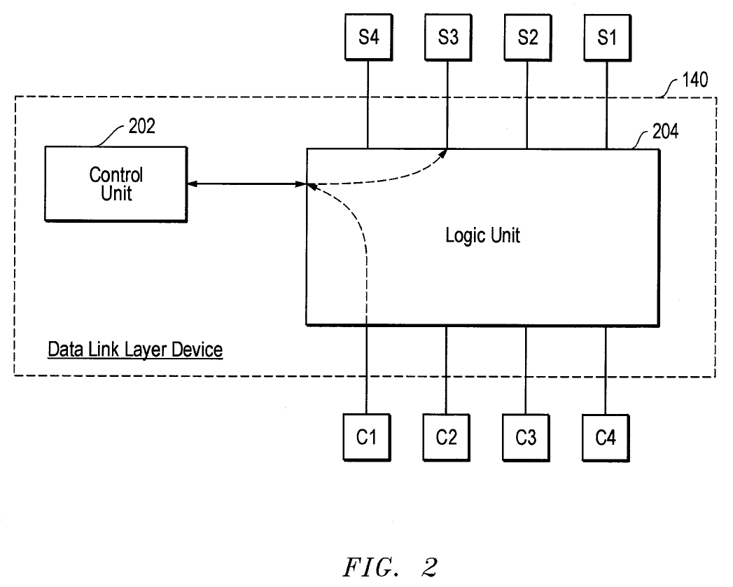

FIG. 2 illustrates a functional block diagram of a data link layer device 140, which includes a logic unit 204 (e.g., an ASIC) that includes a number of ports (eight in this example) that are respectively connected to clients C1-C4 and servers S1-S4. In a typical implementation, a network administrator configures the data link layer device 140 to filter packets including a selected request type. For example, a broadcast packet including a selected request type can be identified by a user datagram protocol/transmission control protocol (UDP/TCP) port addressed by the packet (e.g., a client originated DHCP packet) has source port 68 and destination port 67. The data link layer device 140 is also configured by the network administrator to specify the ports of the data link layer device and VLANs to which the filter applies and server ports that filter packets are to be routed. In operation, the logic unit 204 examines a packet to determine whether the packet includes a certain request (e.g., DHCP request or a network game service request). In this embodiment, when the packet includes the certain request, the packet is routed to control unit 202, which may be, for example, a microcontroller, a general purpose processor, a programmable gate array (PGA), etc. The control unit 202 then routes, via the logic unit 204, the packet to an appropriate server, based upon various criteria. For example, the control unit 202 may route the packet to a server based on a current load of each of a plurality of servers and/or based on a functionality provided by the server. For example, assuming the request could be serviced by any of servers S1-S4, the control unit 202 may route the request to the server with the lowest current load.

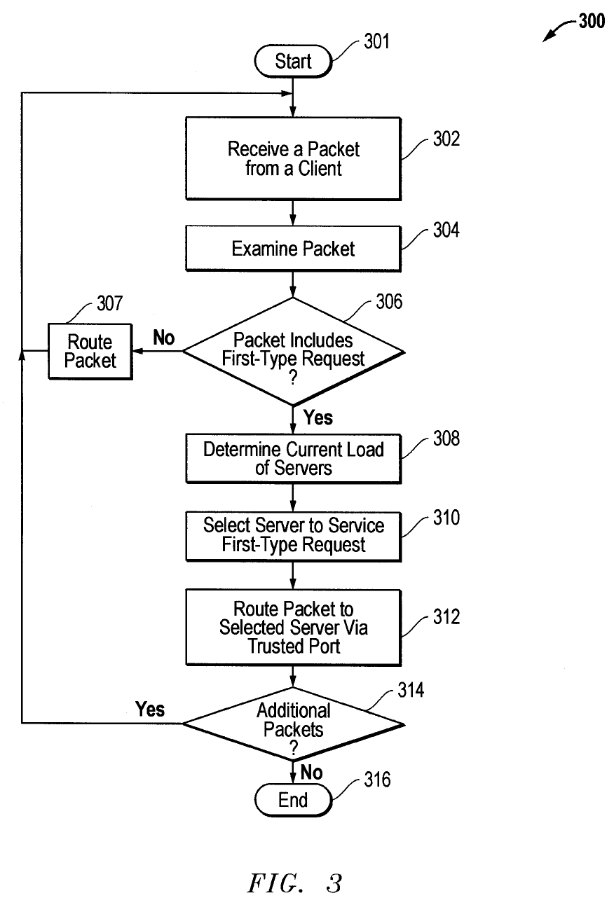

FIG. 3 illustrates a flow diagram of a process 300 for handling a service request in an information handling system. The process 300 of FIG. 3 can be employed in whole or in part by the data link layer device 140 of the information handling system 100 depicted in FIG. 1 or any other type of information handling system operable to employ the process 300 of FIG. 3. Additionally, the process 300 can be embodied in various types of encoded logic including software, firmware, hardware, or other digital storage mediums or logic, or any combination thereof, operable to provide all or portions of the process 300 of FIG. 3.

The process 300 is initiated at block 301 at which point control transfers to block 302, where the data link layer device 140 receives a packet from a client (e.g., client C1 of FIG. 2). Then, at block 304, the logic unit 204 examines the packet. Next, in decision block 306, the logic unit 204 determines if the packet includes a first-type request (e.g., DHCP request or a network game service request). If the packet includes a first-type request, the packet is routed to the control unit 202. Otherwise, control passes from block 306 to block 307 where the logic unit 204 directly handles routing of the packet without involving the control unit 202. From block 307 control passes to block 302.

In block 306 when the packet includes a first-type request, control transfers to block 308 where the control unit 202 determines a current load of servers that are available to service the request. Next, in block 310, the control unit 202 selects a server to service the request. For example, assuming that the request is a network game service request, that servers S1-S3 are game servers, and that the server S3 has the lowest current load, the control unit 202 may select the server S3 to service the request. Then, in block 312, the control unit 202 routes the packet to the server S3, via a trusted port of the logic unit 204. Following block 312, control transfers to decision block 314 where the logic unit 204 determines whether additional packets have been received. If additional packets have been received by the data link layer device 140 in block 314, control transfers to block 302. If additional packets have not been received by the data link layer device 140 in block 314, control transfers to block 316 where the process 300 ends.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures

What is claimed is:

1. A method for handling a service request in an information handling system, comprising:
receiving, at a data link layer device, a packet transmitted from a client, the data link layer device including multiple ports;
examining the packet to determine whether the packet includes a first-type request; and
routing the packet to a server via a trusted port, included within the multiple ports, when the packet includes the first-type request.

2. The method of claim 1, wherein the first-type request is a dynamic host control protocol request.

3. The method of claim 1, wherein the first-type request is a network game service request.

4. The method of claim 1, wherein the server is a dynamic host control protocol server.

5. The method of claim 1, wherein the server is a network game server.

6. The method of claim 1, wherein the routing further comprises:
determining a current load of a plurality of first servers that are each coupled to a respective one of a plurality of trusted first ports, including the trusted port;
selecting, based on the determining, one of the plurality of first servers to service the first-type request; and
routing the packet to the selected one of the plurality of first servers, via an associated one of the plurality of trusted first ports, when the packet includes the first-type request.

7. The method of claim 1, wherein the data link layer device is an Ethernet switch.

8. The method of claim 1, wherein the packet is a broadcast packet or a multicast packet.

9. An information handling system, comprising:
a data link layer device including multiple ports; and
a client coupled to the data link layer device, wherein the client is configured to transmit a packet to the data link layer device and the data link layer device is configured to receive and examine the packet to determine whether the packet includes a first-type request, and wherein the data link layer device is configured to route the packet to a server coupled to a trusted port, included within the multiple ports, when the packet includes the first-type request.

10. The information handling system of claim 9, wherein the first-type request is a dynamic host control protocol request or a network game service request.

11. The information handling system of claim 9, wherein the server is a dynamic host control protocol server or a network game server.

12. The information handling system of claim 9, wherein the data link layer device is an Ethernet switch.

13. The information handling system of claim 9, wherein the packet is a broadcast packet or a multicast packet.

14. A data link layer device for an information handling system, comprising:
a control unit; and
a logic unit coupled to the control unit, the logic unit including multiple ports, wherein the logic unit is configured to examine a packet transmitted by a client and route the packet to the control unit when the packet includes a first-type request, and wherein the control unit is configured to route the packet including the first-type request to a server coupled to a trusted port, included within the multiple ports, via the logic unit.

15. The data link layer device of claim 14, wherein the first-type request is a dynamic host control protocol request.

16. The data link layer device of claim 14, wherein the first-type request is a network game service request.

17. The data link layer device of claim 14, wherein the server is a dynamic host control protocol server or a network game server.

18. The data link layer device of claim 14, wherein the data link layer device is an Ethernet switch.

19. The data link layer device of claim 14, wherein the packet is a broadcast packet or a multicast packet.

20. The data link layer device of claim 14, wherein the data link layer device is further configured to route a packet that does not include the first-type request directly to one of the multiple ports.
